(19) United States
(12) Patent Application Publication
(10) Pub. No.: US 2023/0312132 A1
(43) Pub. Date: Oct. 5, 2023

(54) TWO-WAY HUMAN-MACHINE COMMUNICATION

(71) Applicant: THALES, COURBEVOIE (FR)

(72) Inventors: Aurélien THIRIET, MERIGNAC (FR); Jaime DIAZ PINEDA, MERIGNAC (FR); Daniel HAURET, MERIGNAC (FR)

(21) Appl. No.: 17/928,251

(22) PCT Filed: Jun. 1, 2021
(86) PCT No.: PCT/EP2021/064608

§ 371 Date: Nov. 28, 2022

(30) Foreign Application Priority Data
Jun. 4, 2020 (FR) FR2005823

(51) Int. Cl. B64D 47/00; G06F 40/35; G06N 3/086; G06N 3/042; G06N 3/043; G05B 13/02

(52) U.S. Cl. CPC B64D 47/00; G06F 40/35; G06N 3/086; G06N 3/042; G06N 3/043; G05B 13/0285

(57) ABSTRACT

Systems and methods for improved human-machine dialog, include bidirectional translations notably through the translation of commands by the human into a form able to be manipulated by the machine, and conversely of results produced by the machine into a form intelligible to the human. Some developments describe notably the display of portions of intermediate reasoning followed by the machine (for example explanation of root causes).

### FIELD OF THE INVENTION

The invention relates to the technical field of human-machine interfaces, and describes more particularly examples of systems and methods for human-machine dialog.

### PRIOR ART

In aeronautics, communication between the pilot and complex on-board systems is designed and set up to improve operational performance and mission risk management. The concept of risk is sometimes broken down into risk taking associated with a given action, whether this risk be experienced, imposed or consented to.

To some extent, the risk may be quantified or objectified (for example based on metrics), for example positioned on a graphical scale. Indeed, the concept of risk may be based on pillars or factors that are more quantifiable and measurable. In particular, these factors may correspond to intentions to act, or to concerns brought about by the context (absence or limit of control of constraints).

In the course of interactions with complex systems (referred to as “the machine” or “the machines”), many technical problems may arise. One of the technical problems to be solved may lie in making a complex system “understand” the intentions of the pilot, in order to produce an appropriate technical response. This response notably has to be adapted to the context and be understandable to the pilot.

Various works in the field of psychology may shed light on advantageous technical choices in the control of complex systems. Works by Amalberti [2011] notably make it possible to define the concept of a “cognitive compromise” for the aircraft pilot. This involves controlling the established activity based on a permanent compromise (for example negotiated continuously), underpinned by the time constraints of the dynamic activity, between the external risk incurred (environmental threat) and the internal risk of not carrying out the current process (skills for the cognitive aspect and/or stress/fatigue for the physiological aspect).

In contemporary aeronautics, a pilot adopts and adapts to various levels of abstraction, with a view to interacting with the complex systems installed in his cockpit. However, these levels of abstraction do not always correspond directly to obvious inputs for the technical system. This is the case when the adopted level of abstraction is that of intentions. Each intention is conditional upon the objective of the mission to be carried out, the environment, the tactical situation and the state of the systems. This then leads the pilot to “translate” the intentions into technical terms (that is to say into machine “language”, for example a series of operations) and thus to construct a combination of instructions intended for the system.

This type of translation to and from complex machines may become excessively acrobatic or even impossible when the pilot has to manage numerous systems (notably under severe time constraints), and a fortiori under severe cognitive load, thereby possibly leading to risky situations.

The scientific literature and the patent literature describe few satisfactory solutions to these technical problems, essentially linked to the difficulties encountered in interactions between human and machine.

There is a need for advanced systems and methods for human-machine interactions, and notably bidirectional communication.

### SUMMARY OF THE INVENTION

The document describes systems and methods for bidirectional human-machine communication, notably capable of capturing or receiving or otherwise retrieving the intentions (to act) of the pilot and of translating them into a language understandable to the system (which is then said to be “intelligent”). Conversely, the systems and methods according to the invention make the solutions computed by the system understandable to humans. As the interactions progress, trust in the communication system may increase.

To ensure bidirectional and effective communication between human and complex machine, it is advantageous to capture or retrieve the intentions of the pilot and to translate these data into a language understandable to the machine. At the same time, it is also advantageous to analyze the solutions supplied by the system and to make them understandable to the human. The level of trust may thereby be built up gradually. In other words, systems and methods according to the invention are advantageous for human-machine dialog, and may in particular reduce the semantic gap between the level of abstraction of the operator (called high level) and that of the system (called low level).

In one embodiment, a description is given of a bidirectional communicator for optimizing a dialog or an interaction (succession of actions and display of information from computers, notably from sensors) between an operator and a complex system.

In one embodiment, the use of one or more universal “approximators” may be advantageous for carrying out bottom-up and top-down translation functions. In one advantageous embodiment, the bottom-up translator is configured through supervised learning performed on the operational knowledge collection base. The top-down translator may for its part be configured through reinforced learning employing the complex system and the previously configured bottom-up translator.

In one embodiment, the systems and methods for bidirectional human-machine communication may integrate and use a plurality of translators (for example bottom-up and/or top-down, congruent or competing, arranged in series and/or in parallel) between the operator and the complex system.

These translators may notably be used independently (for example according to the operational requirement, for example controlling the top-down translator, controlling the bottom-up translator in order to be able to explain the response of the system).

The advanced systems and methods described in this document may be advantageous in many technical fields requiring interactions between humans and machines (for example civil engineering, medicine, economic decision assistance systems, etc.). The adaptation of the systems and methods according to the invention to a new technical field may for example make use of new HLOMs (high-level abstraction metrics, for example intentions) and LLOMs (low-level operational metrics).

Advantageously, the methods and systems according to the invention may be used to continuously monitor the synergy of the human/machine pair.

Advantageously, the methods and systems according to the invention may relate to various phases of preparation, modification, evaluation or execution of the mission, during which the level of complexity is high.

Advantageously, the methods and systems according to the invention may implement natural interactions, which are less expensive in terms of cognitive resources, and are capable of establishing a good level of trust between human and machine.

Advantageously, the methods and systems according to the invention may be used in any other field for the management of complex systems, for example notably to control autonomous cars, to manage sensor services in airborne surveillance, interactions with a virtual assistant, etc.

Advantageously, the methods and systems according to the invention may allow the pilot not to exceed the risk level imposed by the hierarchy (for example flight safety and operational risk management).

Advantageously, the methods and systems according to the invention may allow the pilot to detect any discrepancies between his own mental representation of the situation (his intentions) and that of his digital partner.

Advantageously, using universal approximators makes it possible to capture translation functions through machine learning (whereas the increasing complexity of the systems makes manual configuration of the translation functions very tricky per se).

Advantageously, using fuzzy logic makes it possible to manipulate data with a high level of abstraction.

Advantageously, using decision trees makes it possible to evaluate and to understand the suggestions computed by the machines.

### DESCRIPTION OF THE FIGURES

Other features and advantages of the invention will become apparent with the aid of the following description and the figures of the appended drawings, in which:

FIG. 1 illustrates the prior art of human-machine dialog;

FIG. 2 illustrates a few general principles of the invention;

FIG. 3 illustrates one example of a fuzzy logic decision tree used in one embodiment of the invention;

FIG. 4 illustrates one possible generalization of the invention.

### DETAILED DESCRIPTION OF THE INVENTION

Aircraft

According to the embodiments of the invention, an “aircraft” may be a drone, or a commercial plane, or a cargo plane, or even a helicopter, carrying or not carrying passengers, or any element able to be piloted at least partially (intermittently, or periodically, or even opportunistically over time) remotely (by radio link, satellite or the like).

Levels of Abstraction

The embodiments of the systems and methods according to the invention aim to provide the pilot with a communication tool for transmitting high-level instructions to a complex system (top-down direction, or first direction) and vice versa (bottom-up direction, or second direction according to human-machine axiology), for presenting the proposed mode of operation in an understandable manner.

The levels of abstraction manipulated by the invention may be varied. By convention, N levels of abstraction (cascade or nesting of terms) will be enumerated.

In one embodiment, N=5. For example, works by Rasmussen in the field of human-computer interaction are known in design science. These works make it possible to classify an object or a function according to a hierarchy established over 5 levels of abstraction. The lowest of these levels denotes that of physical forms (technical solution/design). The intermediate levels relate to physical processes (interaction/processing of information), general functions and abstract functions (schemes or modes of operation). Finally, the highest level of abstraction is that of functional objectives and intentions. A functional objective denotes what the information is designed for (for example “I want to detect and protect myself at the same time”). An abstract function denotes known or envisaged modes of operation and schemes (for example the electromagnetic waves of the radar and of the jammer interfere with one another). A general function denotes information based on the technical potential of an object (for example, I want a function that uses a compromise to optimize radar detection and jamming). A physical process denotes a type of interaction and information processing operation (depending on the context, I want to choose between a single radar mode, a single jamming mode and a compromise between the two). A physical form relates to the form of the information (symbology).

In some embodiments, the method manipulates HLOM, LLOM, MLOM and LLTP data, acronyms that will be expanded on later.

Universal Approximator

A “universal approximator” generally denotes a neural network. Indeed, a neural network is capable of imitating practically any process, after adjusting its parameters through learning. In mathematical terms, any sufficiently regular bounded function may be approximated with arbitrary precision, in a finite domain of the space of its variables, by a neural network comprising a layer of hidden neurons of finite number, all having the same activation function, and a linear output neuron. This property is not specific to neural networks: many other families of parameterized functions have this property. The special feature of neural networks lies in the “parsimonious” nature of the approximation: with equal precision, neural networks require fewer adjustable parameters than other known approximators.

Machine Learning

Various learning algorithms may be used, in combination with the features according to the invention. The method may comprise one or more algorithms (for example put into competition) from among the algorithms comprising: “support vector machines” (SVM in acronym form); “boosting” (classifiers); neural networks (in unsupervised learning mode); decision trees (“Random Forest”), statistical methods such as the Gaussian mixture model; logistic regression; linear discriminant analysis; and genetic algorithms.

Machine learning tasks are generally classified into two major categories, depending on whether there is a “signal” or learning inputs or “information feedback” or “available outputs”.

The expression “supervised learning” denotes a situation in which the computer is presented with examples of inputs and examples of outputs (real or desired ones). The learning then consists in identifying a web of rules matching the inputs to the outputs (these rules may or may not be understandable to humans).

The expression “semi-supervised learning” denotes a situation in which the computer receives only an incomplete set of data: for example, there are missing output data.

The expression “reinforcement learning” consists in learning the actions to be taken, from experience, so as to optimize a quantitative reward over time. Through iterated experiments, a decisional behavior (called strategy or policy, which is a function that associates the action to be executed with the current state) is determined as being optimum in that it maximizes the sum of the rewards over time.

The expression “unsupervised learning” (also called deep learning) denotes a situation in which no annotation exists (no label, no description, etc.), leaving the learning algorithm alone to find one or more structures, between inputs and outputs. Unsupervised learning may be an objective per se (discovery of hidden structures in data) or a means for achieving an objective (learning by functions).

Depending on the embodiment, the human contribution to the machine learning steps may vary. In some embodiments, the machine learning is applied to the machine learning itself (reflective). Indeed, the entire learning process may be automated, notably by using multiple models and by comparing the results produced by these models. In most cases, humans participate in the machine learning (“Human in the loop”). Developers or curators are responsible for maintaining the masses of data: data ingestion, data cleaning, pattern discovery, etc.

The machine learning may correspond to hardware architectures that are able to be emulated by a computer (for example CPU-GPU), but sometimes are not (circuits dedicated to learning may exist).

Various learning algorithms may be used. The method may comprise one or more algorithms from among the algorithms comprising: “support vector machines” (SVM in acronym form); “boosting” (classifiers); neural networks (in unsupervised learning mode); decision trees (“Random Forest”), statistical methods such as the Gaussian mixture model; logistic regression; linear discriminant analysis; and genetic algorithms.

In hardware terms, depending on the embodiment, the method according to the invention may be implemented on or by one or more neural networks. A neural network according to the invention may be one or more neural networks chosen from among neural networks comprising: a) an artificial neural network (“feedforward neural network”); b) an acyclic artificial neural network, for example a multilayer perceptron, thus differing from recurrent neural networks; c) a forward propagation neural network; d) a Hopfield neural network (a discrete-time recurrent neural network model in which the matrix of connections is symmetric and zero on the diagonal and in which the dynamic range is asynchronous, a single neuron being updated upon each unit of time); e) a recurrent neural network (consisting of interconnected units interacting non-linearly and for which there is at least one cycle in the structure); f) a convolutional neural network (“CNN” or “ConvNet”, a type of feedforward acyclic artificial neural network, based on multilayer stacking of perceptrons) or g) a generative adversarial network (GAN in acronym form, a class of unsupervised learning algorithms).

Fuzzy Logic

Fuzzy logic is a general-purpose logic in which the truth values of variables—instead of being true or false—are reals between 0 and 1. In this sense, it extends conventional Boolean logic with partial truth values. The degree of truth of a fuzzy relationship between two or N objects is the degree of membership of the pair or of the N-tuple to the fuzzy set associated with the relationship.

Advantageously, using fuzzy logic entails using words from a dictionary, which may generally be expressed in natural language (advantageous interface in human-machine interfaces).

Fuzzy Logic Inference System FIS

A “Fuzzy Inference System” (FIS) is a system that uses fuzzy logic to establish the correspondence between input data (features) and output data (classification) or continuous outputs (regression). The choice of defuzzification method will involve either a classification (discrete output) or a regression (continuous output).

Fuzzy inference systems take inputs and process them according to predefined rules so as to produce outputs. Both the inputs and the outputs have a real value, whereas the internal processing is based on fuzzy rules and fuzzy arithmetic.

An FIS generally uses six steps (determine fuzzy rules, fuzzify inputs by membership class, combine fuzzy inputs according to these fuzzy rules, determine one or more consequences of applying the rules, combine the consequences into an output distribution, defuzzify said distribution).

Adaptive Fuzzy Inference System AN-FIS

In one optional embodiment, the method according to the invention may use an ANFIS system, in addition to or as a substitution for fuzzy decision trees.

An adaptive fuzzy inference system or adaptive network-based fuzzy inference system (ANFIS) is a type of artificial neural network that is based on the Takagi-Sugeno fuzzy inference system. The technique was developed in the early 1990s. Integrating both neural networks and fuzzy logic, it makes it possible to harness the advantages of both approaches in a single framework. Its inference system corresponds to a set of fuzzy IF-THEN rules that have a learning capability to approximate non-linear functions. An ANFIS is therefore considered to be a universal approximator. To use the ANFIS more effectively and optimally, it is advantageous to use the best parameters obtained by a genetic algorithm.

Genetic Algorithms

A genetic algorithm belongs to the family of evolutionary algorithms, the purpose of which is to obtain an approximate solution to an optimization problem when there is no exact method (or the solution is unknown) in order to solve it in a reasonable time. Genetic algorithms use the concept of natural selection and apply it to a population of potential solutions to the given problem.

A genetic algorithm generally comprises at least three steps (selection, evaluation, generation through selection and/or mutation).

In a first step, a base population is determined (for example generated or selected). The N sets of parameters (also called individuals) are initialized, for example to a random value. Regardless, the starting population may also be received from a third-party system, or result from a selection from among a set of individuals. In particular, the initialization of the genetic loop may take, at input, the output of this same genetic loop.

In a second step, the population is evaluated. Simulation tools are used for example to carry out a large number of path computations (generally several million or even billions; the larger the number, the more accurate the obtained result, but the longer the simulation time) for each of the N sets of parameters, then each of these sets is evaluated with the evaluation function f. In the example under consideration, it will be possible to choose to simulate all of the existing routes in the procedure database, with a certain number of sets of predictions. In a third step, the best individuals are selected for the next iteration. It is possible for example to retain the 20% of individuals with the best evaluation. It may also be decided to randomly keep 5% of the rest of the population, to keep diversity. Various selection modes are conceivable (for example thresholding, threshold ranges, analytical functions, etc.). In one embodiment, the k samples having the best score (for example k<50) are selected, k being received or computed. In one embodiment, k is predefined. In one embodiment, only the samples having a score greater than a predefined threshold are kept (for example the k samples having a score greater than 70%, if the score is between 0 and 100%). In one embodiment, one or more of the thresholds that are used depend on the iteration of the algorithm (increasing selectivity). In one embodiment, the selection takes place using a “biased wheel” method: the samples are selected in proportion to their score (more high-scoring samples are selected than low-scoring ones). In one embodiment, the B best scores are retained. All of these embodiments may be combined with one another (parametric selection, algorithmic selection though analytical functions).

In a following step, one or more crossovers/mutations are carried out. This step involves adding to the population in order to keep a constant population. This addition may be carried out in various ways. A crossover consists in creating new individuals from other individuals. For example, for two individuals with 4 parameters or “genes” [a, b, c, d] and [a′, b′, c′, d′], it is possible to obtain [a, b, c′, d′] and [a′, b′, c, d]. The crossovers may for example be carried out in pairs (for example by randomly choosing two samples (“father”, “mother”), which are crossed over so as to obtain two new samples (“children”)). In one embodiment, the crossover method is a multiple-point crossover. In one embodiment, the crossover method is a single-point crossover. A mutation consists in randomly modifying an individual of the population, for example by modifying the value of one of the parameters of an individual to a new random value in the defined domain. For example, for an individual with 4 genes or parameters, [a, b, c, d] becomes [a, e, c, d]. The mutations may be carried out by randomly selecting one gene and replacing it with another gene. For example, in one embodiment, the mutation rate may be set at m % (between 0.01 and 2%), and the gene change follows a uniform law.

In a subsequent step, it is determined whether the loop is continued (for example looped back, reiterated), or else stopped. This step involves deciding whether an optimum has been found and, if so, considering the individual with the best evaluation function to be the optimum set of parameters. If not, the computations continue. In general, an optimum is found if the mean of the evaluation function of all of the individuals is close to the best evaluation function of an individual. One alternative may be to simply consider a given value starting from which the population score is deemed satisfactory. The best set of parameters is then determined.

In a subsequent step, the best set of parameters is validated (or not validated) and the performance is quantified. In this step, there is an optimum set of parameters (best individual found in the 5th sub-step). There are also all of the simulations of this set of parameters, thereby making it possible to characterize the performance of the product. If the performance of the product is deemed to be compliant, this validates the parameter set; if not, it will be possible to analyze the causes of these errors and contemplate reviewing the logics and why not introduce new parameters that will have to be configured by restarting the search.

Fuzzy Logic Decision Trees (GFT)

In one development, the machine learning comprises a genetic fuzzy logic decision tree GFT.

In one development, the machine learning comprises implementing a genetic algorithm (2211), which generates the configuration of the GFTs used in the bottom-up and top-down translators, specifically the configuration of the membership functions and of the fuzzy rule bases of each FIS making up the GFT, by breaking down membership functions and rule bases into a plurality of associated genes, and then randomly mixing them and/or randomly replacing one or more genes with others. Advantageously, it will also be possible to encode, into the genes, the very structure of the GFT tree and thus optimize it via the genetic algorithm.

Using fuzzy logic in an FIS (Fuzzy Inference System) makes it possible to develop control orders as a function of inputs. These orders are developed by “linear” laws (at least), depending on “control parameters”. The step of determining orders intended for the FMS/AP may be guided or governed or framed by a fuzzy logic control assembly.

In one embodiment, the machine learning may be used to best configure (or optimize) the FIS control parameters, such that the mission success score is as high as possible (computed by a fitness function).

The FIS or GFT (FIS organized into a tree) intervene in certain aspects as would a pilot who knows his aircraft: the pilot ends up knowing the orders to be developed so as to have an optimum result with regard to the mission.

A tree-like set of FIS may therefore be used to develop the set of parameters associated with the unit elements.

Using genetic mechanisms makes it possible to vary the internal control parameters of the various fuzzy logics and to end up with an optimized set for all of the missions under consideration.

In one embodiment of the invention, the control algorithm may be based on a neural network. Where applicable, the learning is performed through gradient back-propagation, so as to optimize the weightings of the various neurons involved. In one embodiment, in this case, the output of each neuron in the end layer may correspond respectively to the orientation and speed orders of each unit element (similar to what is proposed for the GFT algorithm).

“Black Boxes” Versus “White Boxes”

A black box, between one or more inputs and one or more outputs, denotes a process in which it is not possible to access intermediate data and/or computing rules or, where applicable, these may not be directly intelligible to humans.

A white box denotes a process in which intermediate data and/or computing rules are accessible and directly intelligible to humans.

Genetic Algorithm

In one embodiment, the method uses one or more genetic algorithms. A genetic algorithm iteratively manipulates a set of vectors of real variables using mutation, selection, and crossover operators. A genetic algorithm iteratively manipulates a set of vectors of real variables using operators. A mutation step is performed by adding a random value drawn from within a distribution that is generally normal. The selection is made by deterministically choosing the best individuals, or a recombination, according to the value scale of an objective function. Using a recombination operator generally makes it possible to avoid being trapped in local optima.

Fuzzy Logic Decision Trees GFT (Genetic Fuzzy Trees)

Decision tree-based learning denotes a method based on using a decision tree as a predictive model.

In decision analysis, a decision tree may be used to explicitly represent the decisions that are made and the processes that lead to them. It is a supervised learning technique: use is made of a set of data for which the value of the target variable is known in order to construct the tree (what are known as labeled data), and then the results are extrapolated from the set of test data.

The tree is generally constructed by separating the set of data into subsets according to the value of an input characteristic. This process is repeated on each recursively obtained subset; it therefore involves recursive partitioning.

Some techniques, called ensemble methods, improve the quality or the reliability of the prediction by constructing multiple decision trees from the data (for example bagging, random forest classification, classification and regression tree boosting, decision forest rotation classification, etc.).

Decision trees are sometimes combined with one another or with other learning techniques. Procedures for aggregating the performance of the various models that are used (such as decisions by consensus) are implemented in order to obtain maximum performance, while controlling the level of complexity of the models that are used.

Decision trees correspond to a white box model: if observing a certain situation on a model, this may be explained using Boolean logic, unlike black box models such as neural networks, for which the explanation of the results is difficult to understand.

Decision trees have many advantages: little data preparation (no normalization, empty values to be removed, or dummy variable); management of numerical values and categories.

Advantageously, evolutionary algorithms may be used to avoid separations leading to local optima.

CMA-ES Algorithm

In one embodiment, the method uses a CMA-ES (acronym for “Covariance Matrix Adaptation Evolution Strategies) algorithm, or one of its variants (for example Meta ES or Nested-ED hierarchical evolution strategies).

The CMA-ES algorithm is based notably on adapting, during the iterations, the variance-covariance matrix of the multi-normal distribution used for the mutation.

CMA-ES algorithms are advantageous, in particular for non-convex, non-separable, incorrectly formed, multimode or noisy functions. Studies on black box optimization have shown that CMA-ES is effective under “challenging conditions” or large search spaces. CMA-ES algorithms have also been extended to multi-objective optimization problems (MO-CMA-ES).

A CMA-ES algorithm comprises notably a principle of maximum likelihood (the covariance matrix is updated incrementally such that the likelihood of the previous search steps is increased).

In other embodiments, the CMA-ES algorithm may be replaced by an algorithm for estimating distributions or “Cross-Entropy Method” methods. In other embodiments, the CMA-ES algorithm may be replaced with a “Downhill simplex method” or “Surrogate-based methods”, by “BFGS” or “NEWUOA” or even “Multilevel Coordinate Search (MCS)” methods.

Black Box Optimization

A black box does not display its content (or its accessible content is unintelligible).

The evaluation may have a cost. For simple BBs, it is possible to perform sampling randomly, deterministically or according to predefined schemes. It is also possible to intensify the exploration around a precise point or else to look for borders.

Genetic algorithms with an evaluation function may advantageously be used. These are easy to implement and to parallelize, although there is almost no theory with regard to convergence, and performance is generally fairly poor.

In one embodiment, a description is given of a method for bidirectional human-machine dialog, comprising the following steps:—translating, in what is called a top-down translation, what are called general commands from a predefined semantic framework into input data able to be manipulated by the machine, using one or more universal approximators, for example one or more neural networks and/or fuzzy logic decision trees; and translating, in what is called a bottom-up translation, raw output data determined by the machine into data expressed in said predefined semantic framework, using one or more white boxes comprising one or more fuzzy logic decision trees.

In one embodiment, the method may be learned/optimized such that the bottom-up translation resulting from a given command is the closest to that recorded naturally (communication logs, etc.).

The commands may be abstract or general. A black box, between one or more inputs and one or more outputs, denotes a process in which it is not possible to access intermediate data and/or computing rules or, where applicable, these may not be directly intelligible to humans.

A white box denotes a process in which intermediate data and/or computing rules are accessible and directly intelligible to humans.

A universal approximator may be in white box form or in black box form.

Depending on the embodiment, the top-down translation comprises at least one or more black boxes. These black boxes may be arranged in series and/or in parallel.

The bottom-up (or upward) translation may also use one or more white boxes. The bottom-up translation proceeds from the technical output parameters of the system of systems so as to arrive at suggestions with a high level of abstraction; this translation is performed using fuzzy logic decision trees.

In one embodiment, the method uses a genetic optimization algorithm. A genetic optimization algorithm iteratively manipulates a set of vectors of real variables using mutation and selection operators. A mutation step is performed by adding a random value drawn from within a distribution that is generally normal. The selection is made by deterministically choosing the best individuals, or a recombination, according to the value scale of an objective function. Using a recombination operator generally makes it possible to avoid being trapped in local optima.

A fuzzy logic decision tree captures one or more business logics.

In one embodiment, the method furthermore comprises the following steps: receiving the output data from the machine in response to the input data; comparing the input data with a high level of abstraction captured by the HMI of the pilot and the translated data with a high level of abstraction. This step qualifies or constitutes a cycle {capture, top-down translation, bottom-up translation, rendering}. Millions of cycles may be reiterated. Analog rendering may form part thereof (interface and analog rendering, that is to say up to the limits of human cognition).

In one embodiment, the method furthermore comprises the step of selecting output data from among multiple output data, through filtering and/or thresholding, or notably by traversing the bottom-up translation consisting of GFT fuzzy logic decision trees. A very large number of solutions corresponding to the raw outputs may be produced. These solutions may be filtered in various ways, notably by traversing the bottom-up translation (for example via the business filtering encoded in the GFTs). The computed solutions may be graded or scored (thresholding, min-max, etc.).

In one embodiment, the method furthermore comprises the step of controlling at least one black box using at least one white box, a white box comprising one or more GFT fuzzy logic decision trees. In one embodiment, the method indeed manipulates a white box and a black box.

In one embodiment, the step of controlling a network of top-down black boxes using a bottom-up white box comprises the step of optimizing said black box through machine learning. In one embodiment, the method indeed manipulates a white box (bottom-up translation) against N black boxes (multiple black boxes, that is to say a “network”, according to one arrangement, or a “plurality of” black boxes). The white box may consist of a plurality of white boxes, of a finite number, which white boxes control the optimization of multiple black boxes. The one or more white boxes (bottom-up translation) “encode” the business expertise specific to a field of application. These white boxes are therefore “configured” (in the sense of a manual operation).

A box is said to be black in the sense that the weightings and intermediate states in neural networks are only rarely directly intelligible to the non-expert. The one or more black boxes “encode” (through learning on a mass of data observing the activities of numerous pilots in various aircraft) the top-down translation. BBs allow a large amount of computing power to be injected. Human judgements are etched into the machine, but in a way that is generally not accessible or able to be interpreted. BBs do not encode business expertise (vertical application, field of application).

The method may therefore be “asymmetric” in that the top-down translation in the black box (on the left) is optimized by—is based on—the bottom-up translation (on the right), which is carefully configured, by a human, and which encodes business expertise.

In one embodiment, the asymmetry may be reversed.

The choice to specify or a white box may (notably) be justified by motivations of explicability (“explicable” or “controllable artificial intelligence”).

As the case may be, the translation operations may be “learned” (massive data) or “configured” (frugal manual configuration, simple cases). In reality, all intermediate situations may be observed on the continuum. Automation may be more or less extensive and sometimes (pragmatically) exceed human processing capabilities. The invention provides the BB/WB architecture described in the document, and its various options (for example modifications of the graphs in the GFTs, BB in series and/or in parallel, networks of approximators).

In one embodiment, the method furthermore comprises the step of selecting a network of universal approximators from among multiple networks through machine learning.

In one embodiment, the method indeed manipulates N white boxes and M black boxes. In this type of configuration, with high computational intensity, the algorithms may be put into competition, by clusters or entire networks. The machine portion may therefore be pushed to its limits. For example, it may be the case that current data argue for using a more efficient network than the default network.

In one embodiment, the step of optimizing the graph of the fuzzy inference systems FIS of a GFT is performed through machine learning.

In one embodiment, a universal approximator is a parameterized function and/or a neural network and/or a CMA-ES network. A neural network is a parsimonious approximator. The use of a CMA-ES network is particularly advantageous.

In one embodiment, machine learning comprises implementing a genetic algorithm, which determines the configuration of the GFT fuzzy decision trees used in the bottom-up and/or top-down translators, notably the configuration of the membership functions and the fuzzy rule bases of each fuzzy inference system FIS making up the GFT fuzzy decision tree.

In one embodiment, said configuration is performed by breaking the membership functions and the rule bases down into a plurality of associated genes, and then randomly mixing them and/or randomly replacing one or more genes with others.

In one embodiment, the method furthermore comprises the step of using a genetic algorithm to optimize the structure of a fuzzy logic decision tree.

In one embodiment, the method furthermore comprises the step of updating current data relating to the aircraft or its environment, said data independently modifying the data from the white boxes and/or black boxes. The data refresh rate may be variable depending on the application. The refresh may be extremely slow, possibly years (satellite, Martian robots), but may, conversely, be extremely fast (for example road traffic, intensity of actions).

In one embodiment, the current data are raw data (radar, assembly, cloud) and/or space partition data (peaceful zone, supply zone, etc.); a subset of which is sent to the top-down translation.

In one embodiment, the method furthermore comprises the step of accessing one or more intermediate values manipulated in the GFT fuzzy logic decision trees.

In one embodiment, the method furthermore comprises the step of displaying one or more intermediate values manipulated in the GFT fuzzy logic decision trees.

In one embodiment, one or more of the bottom-up translation white boxes are displayed on demand in a human-machine interface. The white boxes may indeed be “unfoldable” that is to say able to be displayed on request (display intermediate values, root causes, etc.). A fuzzy inference system may be “open”, that is to say displayed or otherwise rendered (for example to see the rules used, display the LLOMs, display one or more levels of abstraction of the dialog, etc.).

In one embodiment, the bottom-up translation is configured through supervised learning (for example the coefficients of the neural networks are adjusted considering a large amount of data, for example a large number of top-down-bottom-up-judgement cycles). In this case, it is advantageous to use supervised learning for the bottom-up tree and reinforcement learning for the top-down tree.

In one embodiment, the top-down translation is adjusted or configured through reinforcement learning based on the configured or trained bottom-up translator. The coefficients of the neural networks and/or of the GFTs may notably be adjusted considering a large amount of data (a large number of top-down-bottom-up-judgement cycles). Advantageously, there is no brute-force combinational logic, and learning may lead to a reduction in the number of states, for example to be used to perform filtering very early on and not just at the very end (in addition to thresholding). The black box optimization of the top-down translation then comes into its own.

In one embodiment, the top-down black boxes are put into competition.

In one embodiment, one or more of the intermediate computing results, information relating to root causes and/or the computing context of one or more of the steps of the method are displayed in a human-machine interface. For example, the display may allow the pressing of a “why” or “explain” button, the actuation of which may trigger the display of one or more of the applied fuzzy logic rules.

The method according to the invention processes structured data. Unstructured data (for example images, videos) may be integrated into the method (a neural network is able to transform unstructured data into structured data). It is also possible to “connect”, to intermediate layers of a neural network, unstructured data, but in a reduced number compared to the input of the neural network.

In one embodiment, machine learning is performed online. In one embodiment, the machine learning is performed offline. The learning data may be historical data. In one embodiment, the machine learning is performed online. Indeed, the machine learning may be performed incrementally or online. When the model is known (weights stabilized in the neural networks and/or GFT) and embedded, it is possible to continue learning as data flow (to improve the existing model, without restarting from scratch). Offline machine learning performs learning on a full set of data, while online learning may continue to learn (“learning transfer”), in an embedded manner, without having to re-ingest the starting data. Advantageously, the learning may be performed beforehand (basic learning, preliminary learning) and then customized on the data specific to a company or to a particular pilot.

In one embodiment, the fuzzy logic uses words from a finite natural language dictionary, that is to say carrying semantics.

Inherently, using fuzzy logic implies intelligibility for the pilot. Using fuzzy logic presupposes the use of natural language words (carrying semantics) and fuzzy logic operators, but not necessarily formed sentences. In one embodiment, the method according to the invention does not manipulate semantics, but syntactic forms or IF . . . THEN . . . rules. In one embodiment, the method according to the invention comprises an (bottom-up or top-down) NLP module.

The lexicon/lexical field is predefined. The machine suggestions are expressed complying with the semantic field of the pilot (in order to make it understandable). If necessary, outputs of the machine are forced onto the words of the dictionary that is used.

Logic—meaning “reason”, “language” and “reasoning”—is the study of formal rules that any correct argument must comply with. Logic uses quantification to express a large sample of natural language suggestions. The pilot may—or may not—validate the system's suggestion.

In one embodiment, the machine learning comprises one or more algorithms selected from among the algorithms comprising: support vector machines; classifiers; neural networks; decision trees and/or steps in statistical methods such as the Gaussian mixture model, logistic regression, linear discriminant analysis and/or genetic algorithms.

In one embodiment, one or more data processing operations are governed by a certified avionics flight management system FMS internalizing predefined constraints.

A description is given of a computer program product, said computer program comprising code instructions for performing one or more of the steps of the method when said program is executed on a computer.

A description is given of a system for bidirectional human-machine dialog comprising—locally and/or remotely accessed memory and/or computing hardware resources, configured to: translate, in what is called a top-down translation, what are called general commands from a predefined semantic framework into input data able to be manipulated by the machine, using one or more universal approximators, for example one or more neural networks and/or fuzzy logic decision trees; and translate, in what is called a bottom-up translation, raw output data determined by the machine into data expressed in said predefined semantic framework, using one or more white boxes comprising one or more fuzzy logic decision trees.

In one development, the method furthermore comprises one or more neural networks configured for machine learning, said one or more neural networks being chosen from among neural networks comprising: an artificial neural network; an acyclic artificial neural network; a recurrent neural network; a forward propagation neural network; a convolutional neural network;—a generative adversarial neural network; said one or more neural networks being emulated in software form and/or being physical circuits.

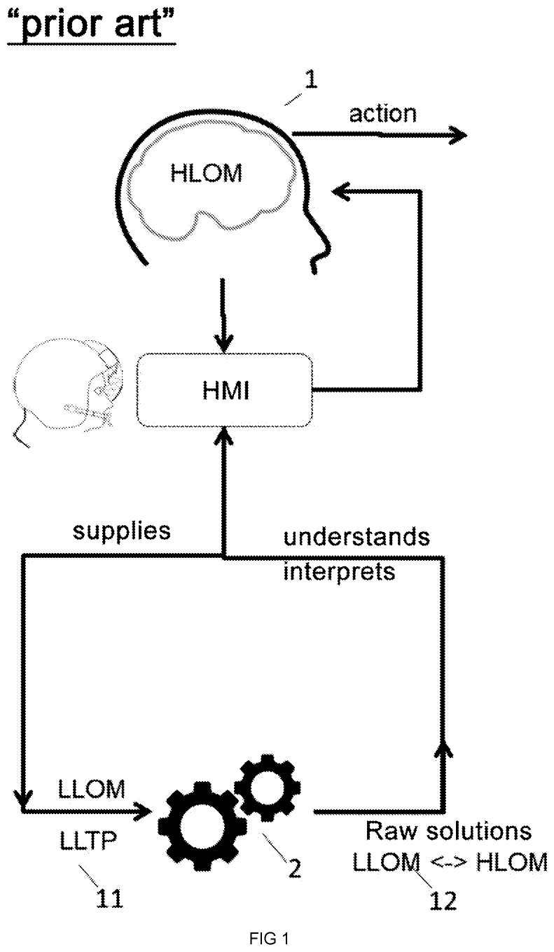

FIG. 1 illustrates the prior art.

A human 1 faced with complex systems or a system of systems 2 has to adapt his “speech”: he has to mentally manage strategy and tactics, that is to say he has to adapt his vocabulary, more generally his inputs, faced with the technical systems that the addresses. Conversely, he has to interpret the results produced by the machine.

Using one or more HMIs 15 (for example speech-to-text, voice control, automatic language processing, physical sensors and/or actuators, gesture control, via touch interfaces, possibly based on data representations in axiological, 2D, 3D, radar view, etc. form), the human 1 provides (quantified and quantifiable) inputs to the complex systems 2.

The complex systems 2 generally require low-level, technical inputs 11, for example a GPS position, and sometimes intermediate abstraction inputs (economic compromise, that is to say “route without tolls”).

After processing the information, the complex system 2 produces solutions according to various levels of abstraction 12 (for example a point on a map, a plot on a map).

The processing of information by the complex system is often brute-force, that is to say not necessarily optimized.

Once again, the human has to interpret the products 12 of the system 2 (for example aggregate, interpret, reprocess).

These common situations indicate that the machine dialog is “asymmetrical” in the sense that the levels of abstraction are imposed on the human being, who has to juggle/deal with various levels of abstraction.

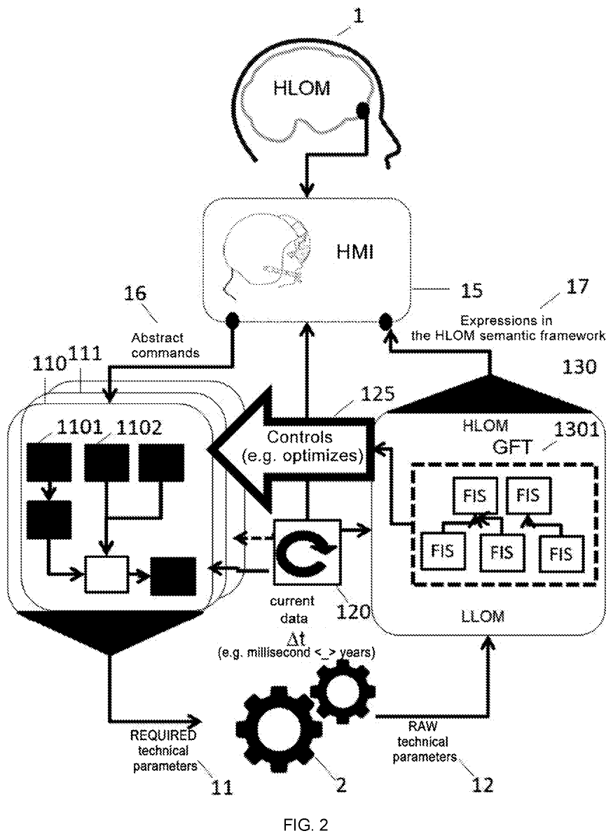

FIG. 2 illustrates a few general principles of the invention.

The invention consists notably in implementing a top-down translation 110 and bottom-up translation 130 for improved dialog between the human 1 and the machine 2 (for example system of systems).

The top-down translation, to change from commands with a high level of abstraction 16 expressed by the pilot to low-level technical parameters 11 required by the system of systems, comprises one or more “black” boxes or universal approximators (GFT and/or RN and/or CMA-ES) that are congruent or competing (series-parallel). These boxes are black in the sense that the weightings in neural networks are only rarely intelligible directly to the non-expert, these black boxes having learned.

The bottom-up translation proceeds from the low-level output operational parameters of the system of systems 2 so as to arrive at suggestions with a high level of abstraction; this translation is performed using fuzzy logic decision trees.

Data with a high level of abstraction (HLOM) 100 supplied by the pilot 1 are translated 110 into a set of data with a low level of abstraction 11 (“technical data with a low level of abstraction” or LLTP) able to be manipulated by the machine system 2.

HLOM (acronym for “High Level Operational Metrics”)

HLOM data denote sets of metrics with a high level of abstraction (intentions), often non-quantifiable, or “fuzzy” (in the sense of fuzzy logic). These data are expressed in the lexical field (or “ontology”) of the operator, making it possible to command an intention to a system (for example: “find a safe and effective solution”, “detect small boats in heavy seas”, etc.).

Some examples of data with a high level of abstraction comprise (for example) objectives, expressed in formal language (UML, symbology, etc.) and/or in natural language, that is to say predefined keywords or expressions or sentences such as “optimize fuel consumption”, “reduce noise on the ground”, “increase the safety level”. Some more complex expressions may also be manipulated (“prioritize fuel consumption over safety”, “reduce altitude despite noise on the ground”, “increase speed and altitude to increase safety”).

LLOM (Acronym for “Low Level Operational Metrics”)

LLOM data denote quantifiable operational metrics, supplied by the system, allowing a human to interpret and judge a service rendered by the intelligent system. They are used by the operational staff when developing their judgement and their understanding of the service rendered.

Some examples of data with a low level of abstraction comprise (for example) (numerical and/or symbolic) values: roll value, angle of attack, pressure value, opening of a solenoid valve, active or inactive state of hardware, etc. These data are possibly associated with technical functions (for example path control).

According to the embodiments, various N intermediate objects may be used, that is to say between the HLOMs and LLOMs. For example, MLOMs (“Mid Level Operational Metrics”) may be metrics able to be read in the intermediate stages of a tree (upward or bottom-up, white box).

Various other terminologies may be associated with these intermediate objects, associated with N distinct levels of abstraction (for example intentions, instructions, tasks, technical parameters), with variable granularities (perimeter definitions). The variety of the objects and the nesting thereof, with or without overlapping, is irrelevant for the claimed method. N may be low (few objects or levels) or high (very large number of sub-levels of abstraction); the method steps may remain essentially the same.

According to one particular aspect, all or some of the manipulated data may depend on the “context” 120, that is to say current data concerning the aircraft. The context may be perceived, measured, informed or otherwise constructed from sensor measurements. The context may be the flight context (take-off phase, cruising phase), but also in accordance with any division of time and/or space (for example approach phase in a given mission, level of priority given from among a predefined plurality, etc.). The “context” thus determined may directly or indirectly influence or control or otherwise modify the manipulated data (selection, different levels of priority, etc.).

According to one particular terminology and hierarchy, provided for the example, the declared “intentions” of the pilot 1 are factors with a high level of abstraction (HLOM) and relate to the conducting of the mission as a whole. The pilot declares intentions 100, for example via “instructions”. These instructions are broken down into “tasks” to be carried out, which are generally combined (linked and implemented simultaneously). For example, the pilot may seek to optimize his fuel consumption while complying with noise constraints on the ground. The parameters with a low level of abstraction (LLOM) 120 relating to the tasks to be carried out are technical, quantifiable, measurable and contribute to the implementation of computing algorithms (often constraint solvers). They are linked to a specific task (optimized path, response to constraints, action plan, etc.). The operational intentions are thus translated 110 into intelligible technical parameters 11 by a decision assistance system 2.

In return, the recommendations of the decision assistance system are expressed 130 in the semantic framework (intentions) of the human. Using known words and/or expressions advantageously makes it possible to contribute to the explicability of the human-machine dialog (in particular in the machine-human direction).

LLTP (Acronym for “Low Level Technical Parameters”)

These data denote parameters with a low level of abstraction that are quantifiable and expressed in the lexical fields (or ontologies) of the system, allowing it to produce a service. The LLTPs correspond to the technical inputs of the system. Each system has a subset of technical parameters at the input so as to ensure correct operation thereof.

Technical blocks TBB (acronym for “Technical Building Block”) denote the functions carried out by the complex system in order to produce one or more “services”.

In one embodiment, each of the bottom-up and top-down directions may be subject to particular and advantageous processing operations, which are described in more detail below.

Top-Down Direction 110

In one embodiment, the top-down translation 110 carries out an ontology translation (drop in abstraction) that has to absorb the “transfer function” of the system. Apart from some very simple cases, a person cannot configure this translator correctly. Advantageously, steps of machine learning for the top-down translation may use a bottom-up translator that has already been configured. In other words, in one embodiment, the bottom-up portion serves as a framework or a fixed point for determining or stabilizing the top-down portion.

In one embodiment, the top-down translator is trained in or by a learning process (for example reinforcement learning), which includes the bottom-up translator that has already been configured in the (processing) chain.

The objective of reinforcement optimization is to reduce the gap between the instruction/the intention (expressed in HLOM), on the one hand; and the characterization of the solution deduced from the instruction (also in HLOM) obtained by traversing the configured bottom-up translator, on the other hand.

In other words, the machine learning process for the top-down translation may advantageously be based on a bottom-up translator that has already been configured.

Like any reinforcement machine learning process, the efficiency and the robustness of the learned model may depend on the variety and the coverage of the input data, here the learning scenarios.

These scenarios are specific to the complex system with which communication is to be established. It involves encoding specialized human expertise.

In general, the top-down translation carries out an ontology translation, that is to say a drop in abstraction (and also has to absorb the transfer function of the system, that is to say the elements that do not come under the NLP).

Bottom-Up Direction 130

In one embodiment, the recommendations of the decision assistance system are expressed 130 in the semantic framework or lexical field of the operator. Using words and/or expressions in natural language (that are predefined and known) allows the pilot to understand the computations performed by the machine.

In one embodiment, the bottom-up translation provides an increase in abstraction within the same (operational) ontology.

Some particular features concerning the bottom-up translation may be noted. It is advantageously in “white box” form so as to allow the operator to understand the service rendered with a different level of abstraction. In one variant embodiment, the bottom-up translation may also be in black box form, if the previous level of explicability is not desired or required (for example by noting only the output or the result of the bottom-up translation). The bottom-up translation may advantageously be adapted to the reasoning of the operating staff to judge the solution (precise information, relevant information, information without ambiguity, etc.).

In one embodiment, one or more multi-criteria decision trees such as a GFT may be used.

Since the technical choice is incumbent on universal approximators configured through learning, various learning methods may be implemented.

In one embodiment, the bottom-up translator may be configured through supervised learning and the top-down translator may be configured through reinforced learning based on the configured bottom-up translator.

In one embodiment, the bottom-up translator is configured with supervision, on the basis of an operational data collection consisting in linking a context, a solution, an LLOM vector (computed or provided) on this solution, and a HLOM vector supplied by the operating staff.

The learning base is tagged and serves as a reference in a supervised learning process aimed at configuring the bottom-up translator.

Feedback 120

The learning loops in order to make the top-down translator converge such that the “distance” between the desired high-level operational metrics supplied at input of the system and the high-level operational metrics observed on the response thereof is minimal over a large number of samples.

In particular, the machine learning of the top-down translator may be carried out so as to make it “converge” (in the sense of stabilizing the hyper-parameters associated with the chosen universal approximator) on the bottom-up semantics.

The “distance” between the desired high-level operational metrics (HLOM) supplied at input of the system (by the pilot 1) and the high-level operational metrics observed on the response thereof (expressed by the decision assistance system 2) should be minimal or at the very least may be minimized over a large number of samples.

The distance may be an edit distance or any other measurement system (metric).

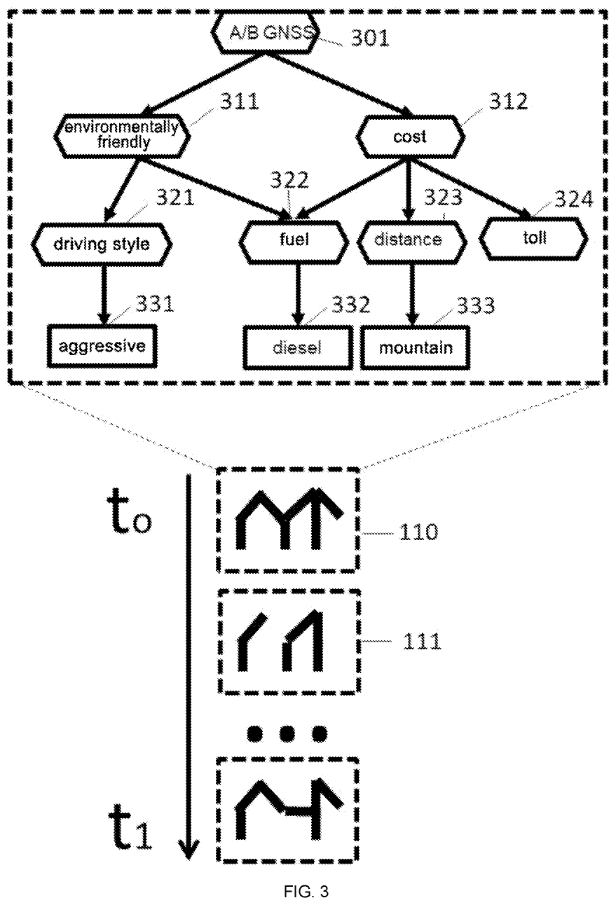

FIG. 3 illustrates one example of a fuzzy logic decision tree used in one embodiment of the invention.

In one advantageous embodiment of the invention, the method uses one or more fuzzy (fuzzy logic) decision trees, for example 110, 111, 112, etc.

A GFT comprises one or more FISs (“Fuzzy Inference System”); for example the tree 110 comprises FISs 301, 311, 312, 321, 322, 323, 324 etc.

In this case, using a human-machine interface, the user tells the machine a destination point 301, to which the machine responds with two possibly adversarial objectives: an environmentally friendly trip 311 and an economical trip without a toll 312. Each of the branches actually corresponds to various possibilities, which are common or mutually exclusive. For example, here, the type of fuel has both an environmental and an economic impact (for example diesel). Driving style, passing through mountains, etc. are also involved. Facts (for example 331) and/or fuzzy rules (for example 312) are manipulated in/by the tree 110.

On a higher level, the system and method according to the invention may arbitrate, that is to say select, between one and several predefined trees, depending on the current conditions (for example depending on whether the car is entering or leaving a freeway network). Moreover, the methods and systems may learn, that is to say modify the structure of the fuzzy decision trees (for example a tree 111 will be derived from a tree 110) through meta-learning.

In one embodiment (not shown), the pilot formulates a compromise, captured by a human-machine interface, between three objectives that may be at least partially adversarial: flight efficiency (achieved or expected result versus a given objective), the endurance of the aircraft (for example representative of the level of material stress) and the safety of the flight or the mission. Some compromises may not make sense, but there are a certain number of (quasi-continuous) solutions. Being totally efficient, for example, would come at the expense of flight safety (by taking reckless risks). In one specific case, the pilot may give first priority to the endurance of his aircraft (called on to perform other missions), and then flight safety, over the effectiveness of the mission.

In other examples (not shown), the number of intentions will depend (notably) on the field, on the operational requirements and on the use context. These intentions may be independent or maintain an adversarial, partially decoupled, proportional linear or non-linear, etc. relationship.

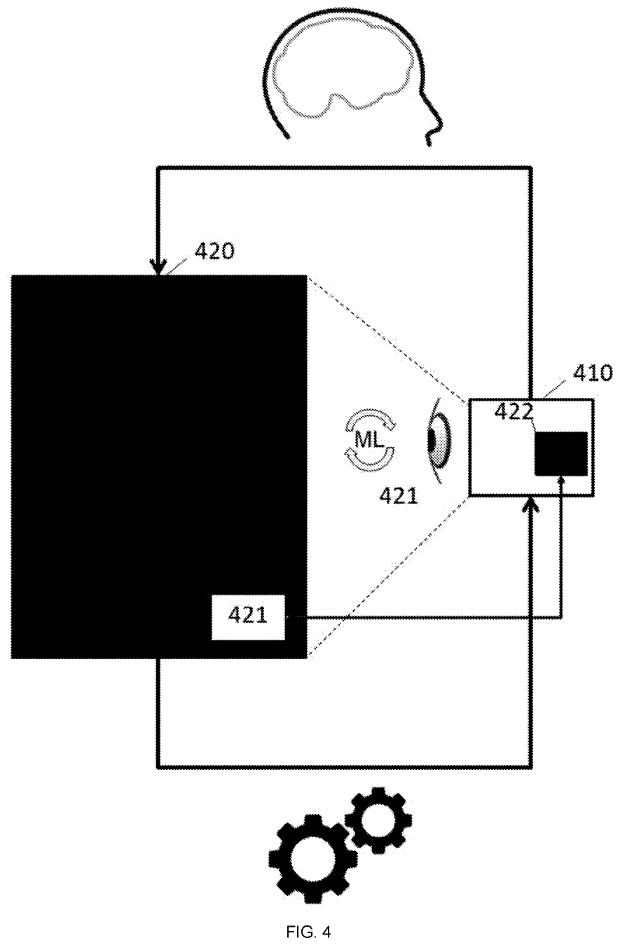

FIG. 4 illustrates one possible generalization of the invention.

In a method in which a black box is an artificial neural network and a white box is a system in which some intermediate states are accessible and expressed in the form of facts and/or fuzzy logic rules expressed using words in a natural language dictionary, a white box 410 for machine-to-human translation may configure, or adjust, or otherwise optimize 421 the parameters of a black box 420 for human-to-machine translation. The black box 420 may comprise one or more white boxes 421, which may symmetrically control one or more black boxes 422 within the white box 410.

Very generally speaking, the white boxes and the black boxes may be arranged in a wide variety of ways: for example in series, in parallel, in competition, in congruence, etc. Arrangement schemes or patterns may follow graphs, be hierarchical, formed in a “fractal” manner (recurrence of a pattern), etc. Part of the computation concerning one or more parameters for which it is advantageous for these to be accessible to human intelligence may thus be subject to one or more white boxes (whose perimeter is sufficient, that is to say a few computing steps upstream and/or downstream), while computations that may be beyond intelligibility (for example millions of correlations, etc.) may remain inaccessible, that is to say in one or more black boxes. In some developments of the invention, the perimeters may be scalable, or even adaptive: a black box may be (at least partially) “opened” into a white box and vice versa. Cross-learning may be performed on different portions of the computing steps and/or the hyper-parameters and/or the inputs/outputs of the black or white boxes.

HMI (15)

The human-machine interaction 15 according to the invention may have various levels of sophistication.

3D, 2D or axiological views are possible. Evaluations with more than 4 degrees of freedom are also possible (these not being shown)

A method according to the invention may comprise one or more feedback loops (for example downstream reacting to upstream, feedforward, etc.). A feedback loop may be “closed”, that is to say inaccessible to human control (it is executed by the machine). It may be “open” (for example step of display in a human-machine interface, validation or any other system for confirmation by a human). Various embodiments may result in different implementations by closing, respectively opening, one or more open, respectively closed, loops.

For example, the method according to the invention may invoke only open feedback loops (that is to say the pilot intervenes at all stages), or else only closed feedback loops (for example total automation), or else a combination of the two (the involvement of a human being variable or configurable). The method (which may be an “artificial intelligence” method) may thus be interpreted as “transparent”, in the sense of being controllable. The display may concern intermediate computing results, information relating to root causes, and/or to the computing context. The method may thus be considered to be “explicable”.

Hardware Means

In one development, the system comprises avionic flight management means of Flight Management System type and/or non-avionic means of Electronic Flight Bag (or “electronic bag”) type and/or augmented reality and/or virtual reality means.

The AR means comprise in particular HUD (“Head Up Display”) systems, and the VR means comprise in particular EVS (“Enhanced Vision System”) or SVS (“Synthetic Vision System”) systems.

The individual display means may comprise an opaque virtual reality headset or a semi-transparent augmented reality headset or a headset with configurable transparency, projectors (pico-projectors for example, or video projectors to project the simulation scenes) or else a combination of such devices. The individual display headset may be a virtual reality (VR) headset, or an augmented reality (AR) headset or a head-up display, etc. The headset may therefore be a “head-mounted display”, a “wearable computer”, “glasses”, a video headset, etc. The displayed information may be completely virtual (displayed in the individual headset), completely real (for example projected onto the flat surfaces available in the real cockpit environment) or a combination of the two (partly a virtual display superimposed or fused with reality and partly a real display via projectors).

In one development, the device comprises means for selecting one or more portions of the virtual display. The pointing operations for the human-machine interfaces (HMI) or portions of these interfaces or information may be accessible via various devices, for example a pointing device of “mouse” type or a designation based on manual pointing; via acquisition interfaces (button, wheel, joystick, keyboard, remote control, motion sensors, microphone, etc.), via combined interfaces (touch screen, force feedback control, gloves, etc.).

The human-machine interfaces may indeed comprise one or more selection interfaces (menus, pointers, etc.), graphic interfaces, voice interfaces, gesture and position interfaces. For example and in one particular embodiment, the information and menus are selected using a designation system (for example using a pointer, via a mouse and/or a trackpad and/or a joystick, through voice control, etc.) supplemented, if necessary, by detection of the gaze direction incorporated into the semi-transparent headset. In one embodiment, these screens may be selected by one or more head movements.

In one embodiment, the method is computer-implemented. By way of example of a hardware architecture suitable for implementing the invention, a device may comprise a communication bus connected to which are a central processing unit (CPU in acronym form) or microprocessor, which processor may be “multicore” or “many-core”; a read-only memory (ROM in acronym form), which may contain the programs needed to implement the invention; a random access memory (RAM in acronym form) or cache memory comprising registers suitable for recording variables and parameters created and modified during the execution of the abovementioned programs; and a communication or I/O interface (I/O being the acronym for “Input/output”) suitable for transmitting and receiving data. If the invention is implemented on a reprogrammable computing machine (for example an FPGA circuit), the corresponding program (that is to say the sequence of instructions) may be stored in or on a removable storage medium (for example an SD card, or mass storage such as a hard disk, for example an SSD) or a non-removable storage medium that is volatile or non-volatile, this storage medium being able to be read partially or fully by a computer or a processor. The reference to a computer program that, when executed, performs any one of the functions described above is not limited to an application program running on a single host computer. On the contrary, the terms computer program and software are used here in a general sense to refer to any type of computer code (for example application software, firmware, microcode, or any other form of computer instruction, such as web services or SOA or via API programming interfaces) that may be used to program one or more processors to implement aspects of the techniques described here. The computing means or resources may notably be distributed (“Cloud computing”), possibly with or using peer-to-peer and/or virtualization technologies. The software code may be executed on any suitable processor (for example a microprocessor) or processor core or set of processors, be these provided in a single computing device or distributed among multiple computing devices (for example as possibly accessible in the environment of the device). Security technologies (crypto-processors, possibly biometric authentication, encryption, chip cards, etc.) may be used.

1. A computer-implemented method for improving bidirectional dialog between human and machine, the method being implemented between a pilot and an aircraft platform, in order to conduct a mission, and comprising steps of:
for the human-to-machine dialog:
receiving, at input of a translation system called a top-down translator data with a high level of abstraction, the data with a high level of abstraction being general commands expressed by the pilot in a predefined semantic framework in order to express an intention regarding the conducting of the mission; and
translating the data with a high level of abstraction into a set of data with a low level of abstraction, the data with a low level of abstraction being technical data, the top-down translation of the human-machine data consisting in supplying, at input, via a human-machine interface, the commands expressed by the pilot to one or more universal approximators based on machine learning, for example one or more neural networks and/or fuzzy logic decision trees, which produce required technical parameters, said required technical parameters being able to be manipulated by a decision assistance system of the aircraft platform in order to determine specific tasks for carrying out the intention expressed by the pilot;
for the machine-to-human dialog:
receiving, at input of a translation system called a bottom-up translator, raw technical parameters from a decision assistance system of the aircraft platform, the raw technical parameters being data with a low level of abstraction representative of tasks recommended by the decision assistance system to carry out an intention expressed by the pilot; and
translating the received data with a low level of abstraction into data with a high level of abstraction, the data with a high level of abstraction being expressions in said predefined semantic framework, the bottom-up translation of the machine-human data consisting in supplying, at input, the raw technical parameters to one or more white boxes comprising one or more fuzzy logic decision trees which produce expressions in natural language characterizing the recommendations of the decision assistance system.

2. The method as claimed in claim 1, further comprising the steps of:
receiving the received data with a low level of abstraction from the machine in response to the input data;
comparing the input data with a high level of abstraction captured by an HMI of a pilot and the translated data with a high level of abstraction.

3. The method as claimed in claim 2, further comprising the step of selecting output data from among multiple output data, through filtering and/or thresholding, or notably by traversing the bottom-up translation consisting of GFT fuzzy logic decision trees.

4. The method as claimed in claim 1, further comprising the step of controlling at least one black box using at least one white box, the top-down translator comprising one or more black boxes, a white box comprising one or more GFT fuzzy logic decision trees.

5. The method as claimed in claim 4, further comprising a step of controlling a network of top-down black boxes using a bottom-up white box, the control step consisting in optimizing said black boxes through machine learning.

6. The method as claimed in claim 1, further comprising a step of selecting a network of universal approximators form among a plurality thereof through machine learning.

7. The method as claimed in claim 1, further comprising a step of optimizing a graph of fuzzy inference systems FIS of a GFT through machine learning.

8. The method as claimed in claim 1, wherein a universal approximator is a parameterized function and/or a neural network and/or a CMA-ES algorithm.

9. The method as claimed in claim 1, wherein the machine learning comprises implementing a genetic algorithm, which determines the configuration of the GFT fuzzy decision trees used in the bottom-up and/or top-down translators, notably the configuration of the membership functions and fuzzy rule bases of each fuzzy inference system FIS making up the GFT fuzzy decision tree.

10. The method as claimed in claim 9, wherein said configuration is performed by breaking the membership functions and the rule bases down into a plurality of associated genes, and then randomly mixing them and/or randomly replacing one or more genes with others.

11. The method as claimed in claim 9, further comprising a step of using a genetic algorithm to optimize the structure of a fuzzy logic decision tree.

12. The method as claimed in claim 4, further comprising a step of updating current data relating to an aircraft or its environment, said data independently modifying the data from the white boxes and/or black boxes.

13. The method as claimed in claim 1, further comprising a step of accessing one or more intermediate values manipulated in the GFT fuzzy logic decision trees.

14. The method as claimed in claim 1, further comprising a step of displaying one or more intermediate values manipulated in the GFTs.

15. The method as claimed in claim 1, wherein one or more of the bottom-up translation white boxes are displayed on demand in a human-machine interface.

16. The method as claimed in claim 1, wherein the bottom-up translation is configured through supervised learning.

17. The method as claimed in claim 1, wherein the top-down translation is adjusted or configured through reinforcement learning based on the configured or trained bottom-up translator.

18. The method as claimed in claim 4, wherein the top-down black boxes are put into competition.

19. The method as claimed in claim 1, wherein one or more of the intermediate computing results, information relating to root causes and/or the computing context of one or more of the steps of the method are displayed in a human-machine interface.

20. The method as claimed in claim 1, wherein machine learning is performed online.

21. The method as claimed in claim 1, wherein the fuzzy logic uses words from a finite dictionary and carrying semantics.

22. The method as claimed in claim 1, wherein the machine learning comprises one or more algorithms selected from among the algorithms comprising: support vector machines; classifiers; neural networks; decision trees and/or steps in statistical methods such as the Gaussian mixture model, logistic regression, linear discriminant analysis and/or genetic algorithms.

23. The method as claimed in claim 1, wherein one or more data processing operations are governed by a certified avionics flight management system FMS internalizing predefined constraints.

24. A computer program product, said computer program comprising code instructions for performing the steps of the method as claimed in claim 1 when said program is executed on a computer.

25. A system for improving bidirectional dialog between human and machine, comprising locally and/or remotely accessed memory and computing resources and data processing resources configured to:
during the human-to-machine dialog:
receive, at input of a translation system called a top-down translator data with a high level of abstraction, the data with a high level of abstraction being general commands in a predefined semantic framework; and
translate the data with a high level of abstraction into input data able to be manipulated by a machine, the top-down translation being carried out by one or more universal approximators based on machine learning, for example one or more neural networks and/or fuzzy logic decision trees;
during the machine-to-human dialog:
receive, at input of a translation system called a bottom-up translator raw output data determined by the machine; and
translate the raw output data into data expressed in said predefined semantic framework, the bottom-up translation being carried out by one or more white boxes comprising one or more fuzzy logic decision trees.

26. The system as claimed in claim 25, further comprising one or more neural networks configured for machine learning, said one or more neural networks being chosen from among neural networks comprising:
an artificial neural network;
an acyclic artificial neural network;
a recurrent neural network;
a forward propagation neural network;
a convolutional neural network;
a generative adversarial neural network;
said one or more neural networks being emulated in software form and/or being physical circuits.
